(19) United States
(12) Patent Application Publication
(10) Pub. No.: US 2023/0408670 A1
(43) Pub. Date: Dec. 21, 2023

(54) PHASE MODULATED PULSE RADAR WITH ANALOG CORRELATOR

(71) Applicant: Regents of the University of Minnesota, Minneapolis, MN (US)

(72) Inventors: Yahya Tousi, Minnetonka, MN (US); Wen Zhou, Minneapolis, MN (US)

(21) Appl. No.: 18/334,828

(22) Filed: Jun. 14, 2023

Related U.S. Application Data
(60) Provisional application No. 63/366,485, filed on Jun. 16, 2022.

(51) Int. Cl. G01S 13/28; G01S 13/00; G01S 7/292

(52) U.S. Cl. CPC G01S 13/288; G01S 13/003; G01S 7/2926

(57) ABSTRACT

A bi-static integrated pulse radar in the millimeter wave band based on a digitally modulated transmitter and an analog processing receiver. The front-end correlator uses a sampler to compress the sensing data, enabling a low-speed and energy efficient digital backend while delivering a high range resolution. The radar may be implemented as a system on chip (SoC) with a total power consumption of a few hundred milliwatts (mW), a surface area of less than four mm² with less than ten percent of the total power corresponding to the analog baseband and digital back-end. The system performance indicates the measured distance from the correlator output has an RMS error of about ten centimeters (cm) and the integral non-linearity is less than ten cm across the entire target range, demonstrating the superior range resolution with superior energy efficiency.

This application claims the benefit of U.S. Provisional Patent Application 63/366,485, filed 16 Jun. 2022, the entire content of which is incorporated herein by reference.

### GOVERNMENT INTEREST

This invention was made with government support under HR0011-20-1-0006 awarded by the Department of Defense/Defense Advanced Research Projects Agency (DARPA). The government has certain rights in the invention.

### TECHNICAL FIELD

The disclosure relates to digital radar systems.

### BACKGROUND

Silicon-based integrated circuits have facilitated the miniaturization and frequency scaling of radar systems. Such systems can expand the use of radars into modern applications such as robotics, precision agriculture, time transfer, and autonomous vehicles.

### SUMMARY

In general, the disclosure describes a multi-static pulse radar in the millimeter wave band, e.g., the E-band, based on one or both of a digitally modulated transmitter and/or an analog processing receiver. The radar system of this disclosure may implement a correlator at the analog front-end (e.g., of the analog processing receiver) prior to any digital processing. The correlator at the analog front-end is referred to as the front-end correlator for ease. In some examples, the front-end correlator may include a multiplier and integrator that in combination realizes the transfer function of a linear matched filter. The filter may be followed by a quantizer and a counter which extends the linear dynamic range of the integrator. In this manner, the front-end correlator uses a sampler to compress the sensing data, enabling a low-speed and energy efficient digital backend while delivering a high range resolution and is interference-resilient. The possibility for large-scale use of such small, energy efficient radar sensors may open new opportunity for distributed sensing and imaging.

In one example, this disclosure describes a radar system comprising: receive circuitry configured to process an analog radar pulse that is digital phase modulated; correlator circuitry configured to: receive the analog radar pulse; receive a bitstream to decode the received radar pulse; perform a correlation function on the received radar pulse based on the bitstream to generate a correlated analog signal; and output the correlated analog signal to digital conversion circuitry.

In another example, this disclosure describes a device implemented in circuitry comprising: receive circuitry configured to process an analog radar pulse that is digital phase modulated; correlator circuitry configured to: receive the analog radar pulse; receive a bitstream to decode the received radar pulse; perform a correlation function on the received radar pulse based on the bitstream to generate a correlated analog signal; and output the correlated analog signal to digital conversion circuitry.

In another example, this disclosure describes a method comprising: receiving, by correlator circuitry, a digitally phase modulated radar pulse; receiving, by the correlator circuitry, a bitstream to decode the received radar pulse; performing, by the correlator circuitry, a correlation function on the received radar pulse based on the received bitstream to generate a correlated analog signal; output the correlated analog signal to digital conversion circuitry.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram illustrating an example implementation of the digital radar system with the correlator at the analog front-end prior to any digital processing.

FIG. 2 is a block diagram illustrating an example implementation of the digital radar system as an integrated system on chip (SoC).

FIG. 3 is a schematic and block diagram illustrating an example circuit implementation of the front-end transmit circuitry for the digital radar system according to one or more techniques of this disclosure.

FIG. 4 is a schematic and block diagram illustrating an example circuit implementation of the front-end receive circuitry for the digital radar system according to one or more techniques of this disclosure.

FIG. 5 is a schematic and block diagram illustrating an example circuit implementation of the local oscillator (LO) circuitry for the digital radar system according to one or more techniques of this disclosure.

FIG. 6A is a schematic and block diagram illustrating an example circuit implementation of the correlator circuitry for the digital radar system according to one or more techniques of this disclosure.

FIG. 6B is a timing diagram illustrating a example signals during circuit operation for the correlator circuitry of this disclosure.

FIG. 6C is a schematic and block diagram illustrating a second example implementation of the correlator circuitry for the digital radar system according to one or more techniques of this disclosure.

FIGS. 7A, 7B and 7C are conceptual diagrams illustrating an example numerical model setup and numerical modeling results for the radar system of this disclosure.

FIG. 8A is an example measurement setup and test results for the digital radar system of this disclosure.

FIGS. 8B and 8C are graphs illustrating the test results from the measurement setup for the radar system of this disclosure.

FIG. 9 is an example phase modulated radar system.

FIG. 10 is a flowchart illustrating an example operation of the digital radar system of this disclosure.

### DETAILED DESCRIPTION

A multi-static pulse radar in the millimeter wave band, e.g., the E-band, based on one or more of a digitally modulated transmitter and an analog processing receiver. A bi-static radar is a radar system comprising a transmitter and receiver that are separated by a distance, e.g., a distance comparable to the expected target distance. Conversely, a radar system in which the transmitter and receiver are co-located is called a monostatic radar. A multi-static radar system may include multiple spatially diverse monostatic radar or bistatic radar components with a shared area of coverage. The front-end correlator for the receiver circuitry of the radar system of this disclosure uses a sampler to compress the sensing data, enabling a low-speed and energy efficient digital backend while delivering a high range resolution and is interference-resilient. The radar system of this disclosure may implement the correlator at the analog front-end prior to any digital processing. In some examples, the front-end correlator may include a multiplier and integrator that in combination realizes the transfer function of a linear matched filter. The filter is followed by a quantizer and a counter which extends the linear dynamic range of the integrator.

In other examples of radar systems, some recent efforts have focused on increasing the baseband modulation bandwidth of radars in order to scale the range resolution of the radar system. In this realm, millimeter-wave frequencies provide extended bandwidth which in theory enables radars to achieve much higher sensing resolution. Among the two mainstream radar topologies, frequency modulated continuous wave (FMCW) modulation has been widely used for the simplicity in its baseband processing. However, the synthesis of a fast, linear chirp used by FMCW modulation at millimeter wave (mm-wave) frequencies is known to be challenging. The linearity of the chirp signal directly impacts the resolution and the absolute range measured by the FMCW radar.

In other examples, phase modulated radars provide an alternative method of modulation that alleviates the need for a tunable high frequency signal source. Because of the digital nature of the phase modulated radars, scaling the resolution of a phase-modulated radar may use a digital processing speed which is compatible with modern technology scaling. However, the existing phase-modulated radars perform within the desired parameters only with high-speed and high effective number of bits (ENOB) samplers for digital implementation of the correlation function. The effective number of bits is a way of quantifying the quality of an analog to digital conversion. A higher ENOB means that voltage levels recorded in an analog to digital conversion may be more accurate.

Scaling up the detection resolution and the digital clock puts more stringent requirements on the high-speed data converter and results in a design bottleneck. As a result, despite the benefits of some phase modulated radars for accurate and scalable sensing, wide-band giga-samples per second (GS/s) phase modulated radars are presently prohibitively power hungry. A GS/s is a measure of the digitizing rate for the radar system. The convolution operation in such phase modulated radars is typically performed in the digital domain requiring a high performance analog-to-digital converters (ADCs) that impose a scaling limit on speed and resolution for these types of radar systems. In contrast, the radar system of this disclosure implements the correlator at the analog front-end prior to any digital processing which enables high speed and energy efficient processing at scale.

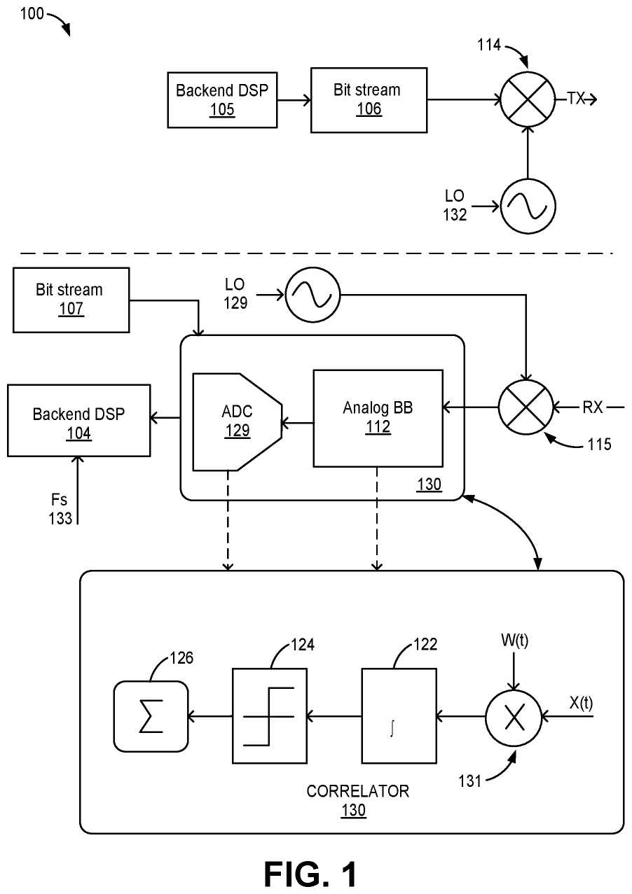

FIG. 1 is a block diagram illustrating an example implementation of the digital radar system with the correlator at the analog front-end prior to any digital processing. System 100 demonstrates one possible proposed radar architecture of the digital pulsed radar system of this disclosure, although other implementations may also demonstrated the techniques of this disclosure. As seen in the example of FIG. 1, radar system 100 includes a transmit side and a receive side that are separate from each other. Each of the transmit and the receive side may include a separate digital backend and a local oscillator as in the example of system 100. In other examples, the transmit side and the receive side may be implemented in a single system, e.g., with a single local oscillator.

For the transmit circuitry, digital signal processor 105 may output a bitstream digital output to the transmit circuitry, e.g., amplifiers, filters and antennae not shown in FIG. 1. Mixer 114 upconverts bitstream output 106 by mixing with the output from oscillator (LO) 132. Bitstream 106 may be implemented in a variety of ways, e.g., various types modulation including phase modulation, multi-level, and similar modulation techniques.

On the receive side, system 100 implements correlator 130 at the analog front-end prior to any digital processing, e.g., by back-end digital signal processing (DSP) circuitry 104, which may receive sample frequency Fs 133. On the receive side, mixer 115 down-converts the reflected radar signals, e.g., the analog echo signals from a target (not shown in FIG. 1). Such echo signals may be used for such applications as distance measurement, 3D imaging and other similar applications. In other examples, the transmit (TX) antenna may output a radar pulse directly to a separate receive (RX) antenna, e.g., located some distance apart, which may be useful for such applications as time transfer, such as synchronization of multiple clocks in communication systems, for example, low delay, ad hoc communication networks.

The received analog signals may be captured by an antenna and processed through receive circuitry, e.g., filters and amplifiers (not shown in FIG. 1). Mixer 115 outputs the result to correlator 130, which may include analog baseband circuitry 112 and ADC 129.

In more detail, the example front-end correlator 130 of FIG. 1 includes a multiplier 131 and integrator 122 that in combination realizes the transfer function of a linear matched filter. The filter is followed by a quantizer 124 and a counter 126, which extends the linear dynamic range of the integrator. One technique to evaluate the performance of this front-end correlator, may include a numerical model using a binary Golay sequence, which minimizes the side-lobes by combining the correlation output of two complementary sequences. Two sequences whose aperiodic autocorrelations sum to zero in all out-of-phase positions are called a pair of Golay complementary sequences, and may be defined over an alphabet of various sizes, e.g., size 2 (binary), 4 (quaternary) or 8 (octary). Golay sequences have been used in digital communication applications for which Barker sequences are not available, because Golay sequences exist for infinitely many lengths, even in the binary case, as used in this disclosure.

Unlike other phase modulated radar systems in which the convolution operation in is typically performed in the digital domain and therefore uses high performance ADCs that impose a scaling limit on speed and resolution, correlator 130 performs the convolution operation on the received analog echo signals. As noted above, by implementing the correlator at the analog front-end prior to any digital processing, radar system 100 may provide advantages over other types of digital radar systems, because the architecture of system 100 may enable high speed and energy efficient processing at scale.

In other words the phase-modulated radar scheme of this disclosure relies on analog processing demonstrating wide bandwidth and energy-efficient bistatic sensing. The radar system of this disclosure may provide advantages over, for example, previous low frequency modulation (LFM) and digital phase modulated (PM) radar systems. Both LFM and PM radars have their strengths and limitations when it comes to precision sensing. LFM radars may have a broad frontend bandwidth while only requiring a low speed and energy-efficient backend processing. Having modulation and demodulation both occurring in the analog frontend alleviates the need for complex digitization. However, frequency modulation (FM) places challenging requirements for the chirp bandwidth and linearity. On the other hand, PM relies on binary phase modulation in the digital backend which is a fundamentally linear approach. However, the linearity of the digital-to-analog convertor in the transmitter and the analog-to-digital converter in the receiver become critical constraints and impose high-power consumption requirements at such large bandwidths. Nonetheless, PM radars provide a higher level of reconfigurability, and adaptability to different use cases and environments.

The radar sensors in the system of this disclosure may benefit from the low-power analog processing of LFM and the digital adaptability of PM while avoiding the complex frequency synthesis and high-speed digital processing often used in these two respective methods. Radar sensor nodes with features like high energy efficiency and digital adaptability may be well-suited as building blocks for distributed sensing. In general, distributed sensing may be advantageous over mono-static sensing in several use cases including indoor localization as it may provide a broader field of view, better spatial resolution and is less susceptible to self-interference than mono-static sensing.

In some examples, the receive circuitry of system 100 may receive transmissions (direct or echo signals) from multiple transmitter circuits. The receive circuitry may receive a first bitstream signal from bitstream generation circuitry 107 (e.g., a memory controlled by processing circuitry) to decode the received signals from a first transmitter. The receive circuitry may sequentially receive a second bitstream signal from bitstream generation circuitry 107, to decode the transmission received from a second transmitter. In other examples, the receive circuitry may include two or more correlator circuits 130 (not shown in FIG. 1). Each correlator circuit may receive a bitstream to decode the transmissions from a specified transmitter. With multiple correlator circuits, the receive circuitry may process received transmissions in parallel, which may allow for higher speed communication. Multiple correlator circuits may also result in increased size, cost, complexity and power consumption.

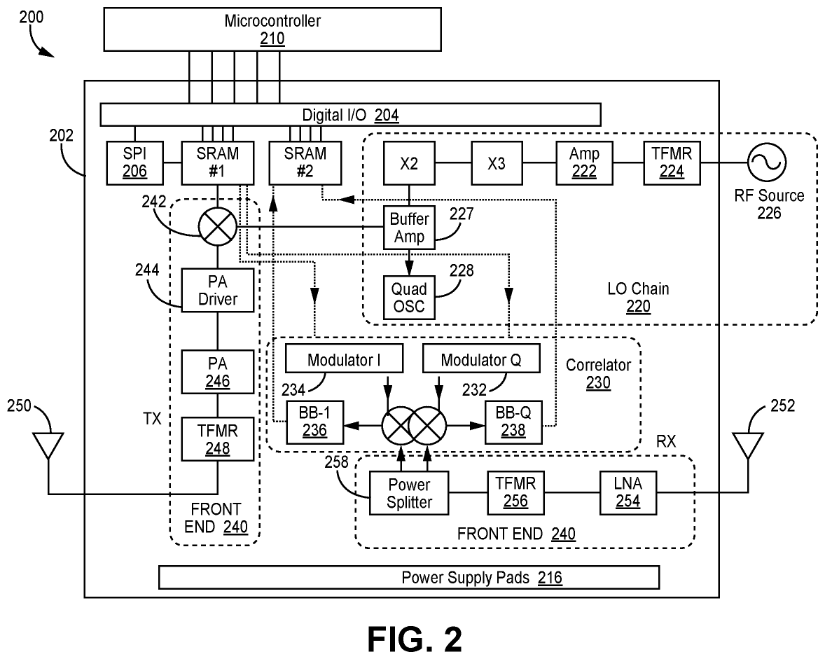

FIG. 2 is a block diagram illustrating an example implementation of the digital radar system as an integrated system on chip (SoC). System 200 is an example of system 100 described above in relation to FIG. 1. However, in other examples, system 200 may implement the transmitter circuitry and the receive circuitry separately, as shown in FIG. 1. In other examples, system 200 may implement the circuitry as a set of individual components rather than as an integrated circuit.

In addition, the example of system 200 depicts just one possible architecture for the receive circuitry of this disclosure. For example, quadrature detection in the example of system 200 uses parallel in-phase and quadrature paths to measure the phase and amplitude of the received signal. In other examples, receive circuitry of this disclosure may use other techniques to measure the phase and amplitude of the signal, such as switching between in-phase and quadrature measurements rather than in parallel (not shown in FIG. 2).

System 200, in the example of FIG. 2 describes the architecture of the proposed mm-wavelength, e.g., E-band radar. The carrier frequency signal is generated from a subharmonic external source, RF source 226 through LO chain 220, which includes of multipliers, e.g., X2 and X3, amplifier 222, signal transformer 224 and an inject-locked quadrature oscillator 228. System 200 may also include serial peripheral interface (SPI) 206.

For the transmitter, mixer 242 directly upconverts the baseband waveform extracted from the on-chip SRAM #1 to the carrier frequency and passed to the transmit horn antenna 250 via two stages of power amplifiers, e.g., PA driver 244, power amplifier 246, and signal transformer 248. The receiver first amplifies the received echo signal, e.g., with LNA 254, and then diverts the received signal to both the I and Q down-conversion circuits BB-I 236 and BB-Q 238 via signal transformer 256 and power splitter 258. Analog front-end 240 may include both the transmit circuitry and the receive circuitry. If implemented separately, in some examples, SRAM #1 may be implemented as two separate memory circuits. A first circuit to provide the digital output to the transmitter circuitry, e.g., to PA driver 244. The receive circuitry may include a separate memory circuit connected to modulator I 234 and modulator Q 232, rather than connected to SRAM #1.

System 200 realizes the correlation function 230 through the modulator, down-converter mixers and baseband (BB) blocks, e.g., modulator I 234, modulator Q 232. A time delayed copy, e.g., through buffer amp 227, of the transmitted waveform is mixed with the quadrature carrier and then multiplied with the amplified echo signal. The multiplication product is integrated inside the circuitry of the baseband module. In the example of FIG. 2, baseband modules 236 and 238 may include digital conversion circuitry to output a digital signal to an on-chip SRAM, in the example of FIG. 2. The multiplication product is subsequently stored in the on-chip SRAM, e.g., SRAM #2. As described above in relation to FIG. 1, in some examples, when the transmit circuitry is separate from the receive circuitry, the receiver may receive signals directly from the transmitter, rather than an echo signal reflected from a target.

In some examples, radar system 200 may operate with a tunable 100 MHz to 2 GHz baseband bandwidth, as well as other frequencies. The front-end correlator 230 may provide more than 54 dB dynamic range. The adjustable digital waveform length and the counter-based digitizer enables a large receiver dynamic range for long-distance range sensing.

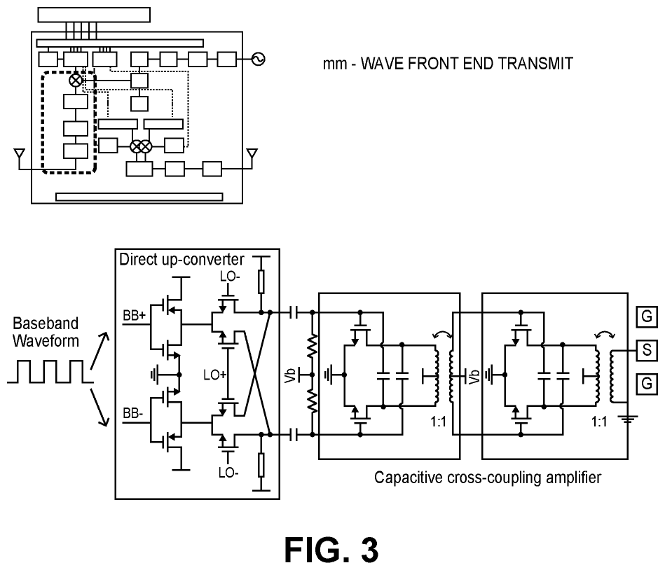

FIG. 3 is a schematic and block diagram illustrating an example circuit implementation of the front-end transmit circuitry for the digital radar system according to one or more techniques of this disclosure. FIGS. 3-6A describe the circuit implementation of the digital radar architecture of this disclosure and further elaborates on the design of the transmitter and receiver components.

The circuitry of FIG. 3 is an example of the mm-wave transmit front-end 240 described above in relation to FIG. 2. As shown in the example of FIG. 3, the transmitter modulates the digital baseband sequence and transmits it through the carrier frequency. It is composed of a direct up-converter and a two-stage differential PA followed by a transformer which provides matching to the 50Ω load. We utilized the capacitive cross-coupled neutralization technique to cancel C_{gd} and enhance reverse isolation of the differential mode. Furthermore, the inductance of inter-stage transformers forms a π-matching network with the parasitic capacitance of the amplifiers that further extends the resulting bandwidth.

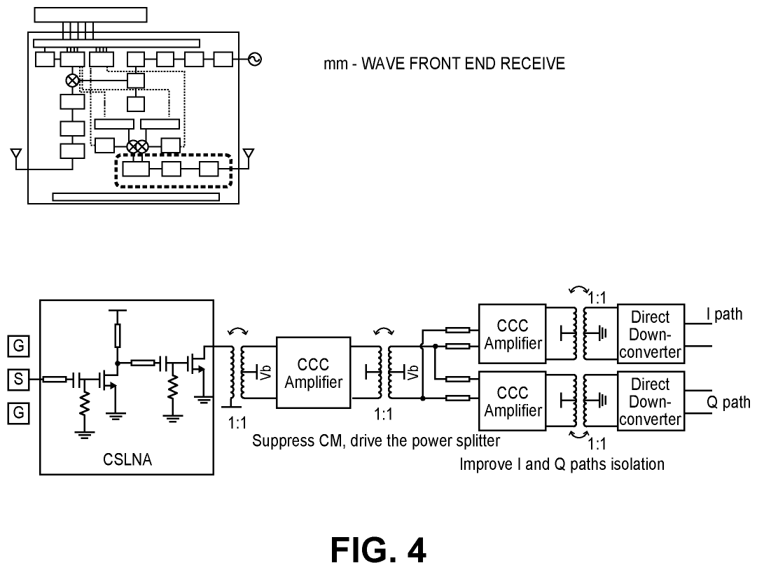

FIG. 4 is a schematic and block diagram illustrating an example circuit implementation of the front-end receive circuitry for the digital radar system according to one or more techniques of this disclosure. The circuitry of FIG. 4 is an example of the receive front-end 240 described above in relation to FIG. 2.

The input signal in the example of FIG. 2 passes through a two-stage common-source LNA followed by an on-chip balun. The balun (a contraction of balanced-unbalanced) is a three-port component placed to connect a single-ended, ground-referenced source and the differential, balanced load, or vice-versa. The common-mode component at the output of the balun is further suppressed by a differential amplifier. This amplifier also drives two differential paths that connect to the I-Q down-converters. Since the impedance of the following down conversion mixer varies with modulation, the receive circuitry of FIG. 2 employs a high-gain amplifier that provides more than 20 dB reverse isolation to isolate the two paths.

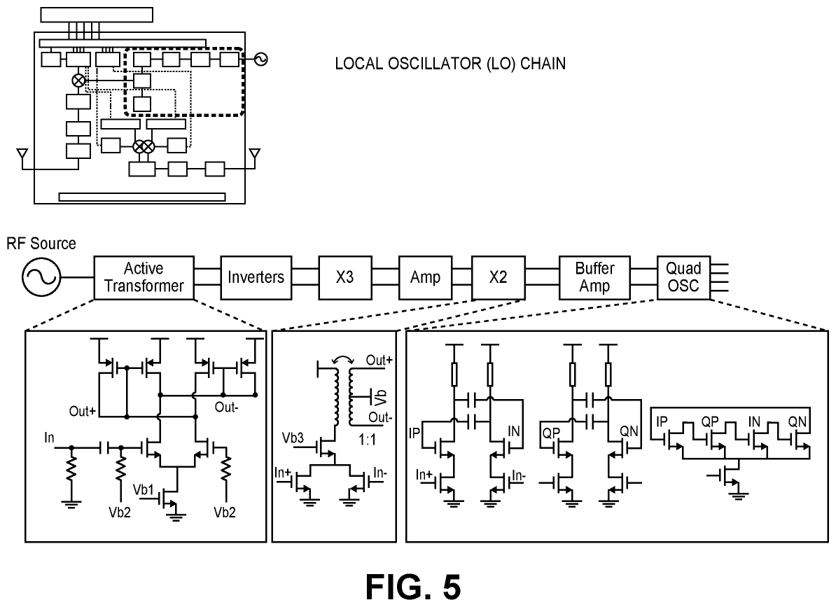

FIG. 5 is a schematic and block diagram illustrating an example circuit implementation of the local oscillator (LO) circuitry for the digital radar system according to one or more techniques of this disclosure. The circuitry in FIG. 5 is an example implementation of LO chain 220 and RF source 226 described above in relation to FIG. 2.

As shown in FIG. 5, the LO frequency is produced through a chain of frequency multipliers followed by an injection locked quadrature oscillator. The example of FIG. 5 includes a 11 GHz input reference that drives an active transformer and a chain of inverters. The active transformer consists of a gm-boosting cross-drain-coupled differential pair in parallel with a diode-connected PMOS load. The gm-boosting, e.g., conductance boosting, is the electrical characteristic relating the current through the output of a device to the voltage across the input of a device. Conductance is the reciprocal of resistance.

The first two stages are designed without any inductive load, which minimize substrate coupling of the LO and deliver a compact layout. The frequency tripler is a differential cascode amplifier with the common-source stage biased at class-C. The frequency tripler is followed by a two-stage common-source amplifier to filter and further amplify the third harmonic. The frequency doubler has a push-push topology with a cascode stage that increases the output resistance for higher conversion gain. The output of the frequency doubler passes through a buffer amplifier and provides the inject-locking signal to the quadrature oscillator. This final quadrature oscillator stage consists of two oscillators interlocked via a 4-stage ring oscillator.

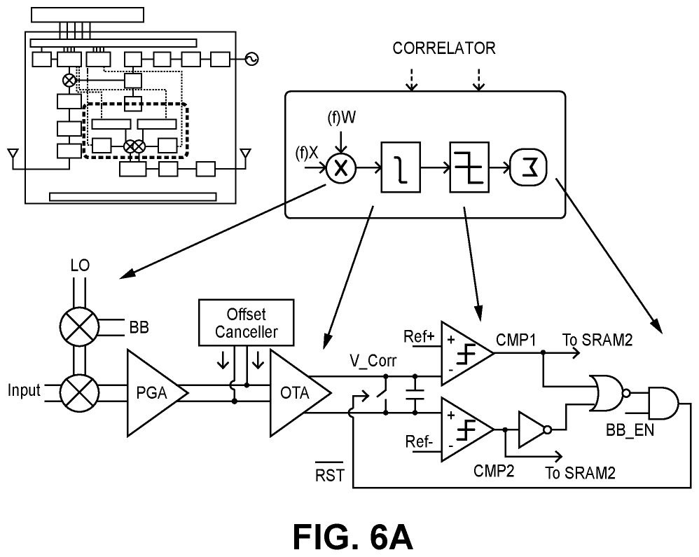

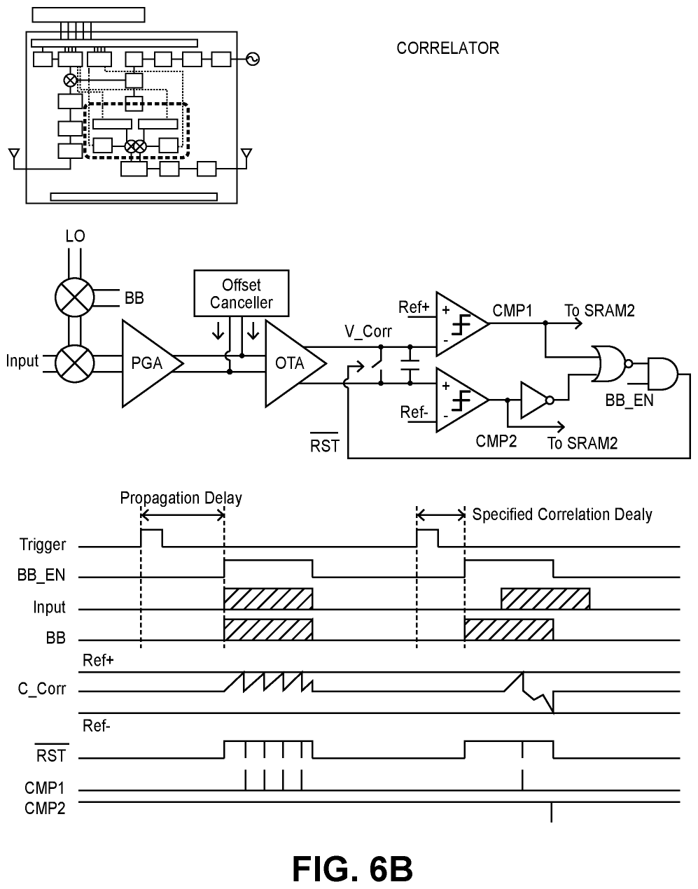

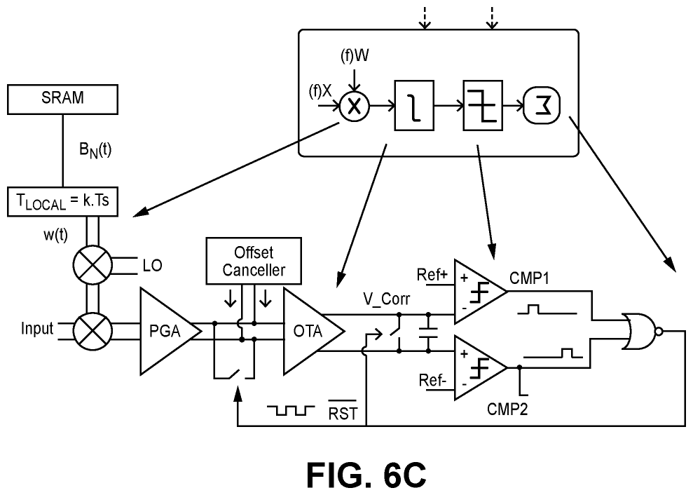

FIG. 6A is a schematic and block diagram illustrating an example circuit implementation of the correlator circuitry for the digital radar system according to one or more techniques of this disclosure. FIG. 6A is an example of correlator 130 and correlator 230 described above in relation to FIGS. 1 and 2.

The example of FIG. 6A shows the diagram of the proposed baseband signal processor. At the last stage of the receiver front-end, the input signal is directly down-converted with the modulated LO. The output is then fed into a 3-bit programmable gain amplifier (PGA) to adjust the signal level applied to the integrator. For wideband operation of the integrator we use a Gm-C configuration based on a capacitively loaded amplifier, e.g., an operational transconductance amplifier (OTA). This enables the integrator to maintain a large RC time constant while enabling high speed operation. For maximum receiver sensitivity, we apply current-based offset cancellation at the OTA input to minimize DC integration. Two highspeed clocked comparators detect when the integrator output ramp approaches a maximum positive or a minimum negative threshold. Once the output passes through either references, the integrator resets and restarts from zero. Depending on whether the positive or negative comparator is triggered, the counter output changes by a positive unit or a negative unit. This mechanism enables the dynamic range of the Gm-C integrator to extend beyond its intrinsic voltage-limited range.

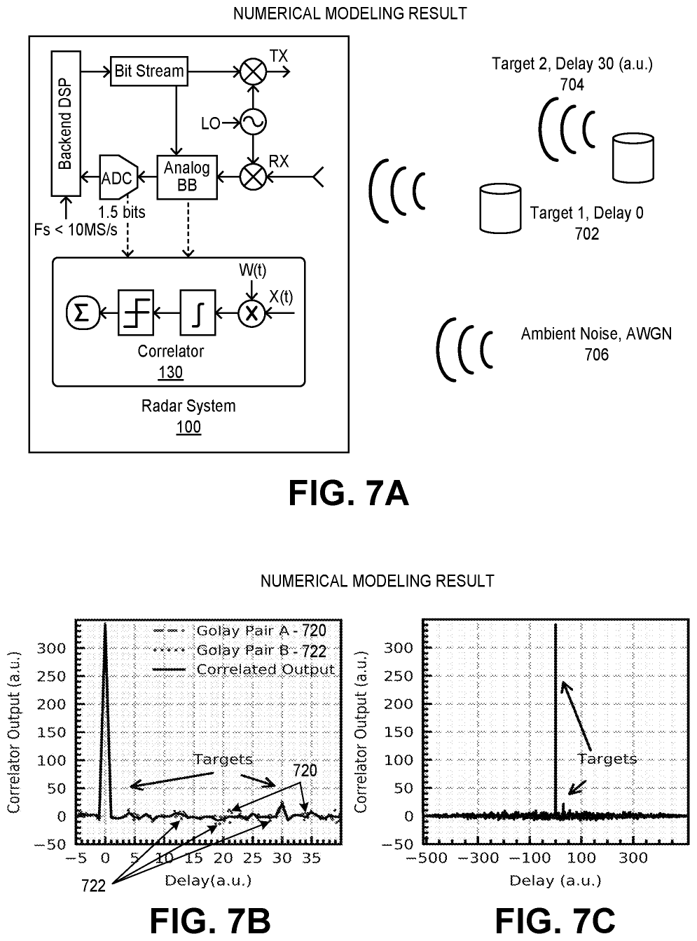

FIG. 6B is a timing diagram illustrating a example signals during circuit operation for the correlator circuitry of this disclosure. The timing diagram in FIG. 6B shows the operation of the baseband in the presence of a target with a fixed propagation delay. When the propagation delay of the signal reflected from the target equals the corresponding roundtrip delay, the correlator output reaches its peak magnitude and results in a maximum number of reset events. When they are not equal, the selected modulation waveform suppresses the side-band and results in a low-amplitude fluctuation as indicated below in FIGS. 7B and 7C.

FIG. 6C is a schematic and block diagram illustrating a second example implementation of the correlator circuitry for the digital radar system according to one or more techniques of this disclosure. FIG. 6C is a functional diagram of the receiver analog baseband which includes the PGA, the OTA, and the differential comparator. FIG. 6C is another example of the circuitry described above in relation to FIG. 6A. In FIG. 6C, a NOR logic gate compares the output of the comparators to generate an inverse reset signal (R̅S̅T̅).

In some examples the incoming signal and the local sequence are delayed by the same amount and in other examples the signals may have delay difference, e.g., one clock period (1 ns). The corresponding waveforms at the analog baseband, e.g., the integrator output and the comparator response in the presence of a target when the local delay matches the propagation delay of the target. In the “no delay” scenario, the integrator output rises consistently which may lead to multiple integrator resets and results in accumulation in the counter. In the delay scenario, the same target is configured with a local delay that is mismatched with the signal propagation delay. In the delay scenario, despite significant fluctuations in the integrator output, the overall accumulated digital output may still be zero or approximately zero.

FIGS. 7A, 7B and 7C are conceptual diagrams illustrating an example numerical model setup and numerical modeling results for the radar system of this disclosure. FIG. 7A illustrates an example setup with radar system 100, described above in relation to FIG. 1, configured to detect targets in the field of regard (FOR) of system 100. FIGS. 7B and 7C illustrate correlation results for the two targets: target 702 at 0 unit delay and target 704, further away from system 100 with 30 unit delay across nearby points (FIG. 7B) and the entire waveform (FIG. 7C).

FIGS. 7B and 7C show the results of the simulation that mimics the behaviors of the baseband with the analog correlator during radar sensing operation. The simulation assumes two targets, target 702 at delay zero arbitrary units (a.u.), with 0 dB reflection power level, and target 704 at delay of 30 (a.u.), e.g., further away and with a reflected power of −40 dB compared to target 702, e.g., a smaller target. In this disclosure, the arbitrary unit refers to a relative term, e.g., microseconds, milliseconds, nanoseconds or similar time units. The numerical modeling included an additive white Gaussian noise at −30 dB included across all delays.

The example of FIGS. 7A-7C used a 512-bit Golay pair, the calculated processing gain of correlator 130 is 27 dB, which enables the baseband to detect a target below 0 dB signal to noise ratio (SNR). In this manner, FIGS. 7B and 7C describe the combined correlation output waveform of various delays showing two distinctive peaks. The results show that the correlator of this disclosure, e.g., correlator 130, enhances the input SNR and separates the stronger and weaker signals at different time delays.

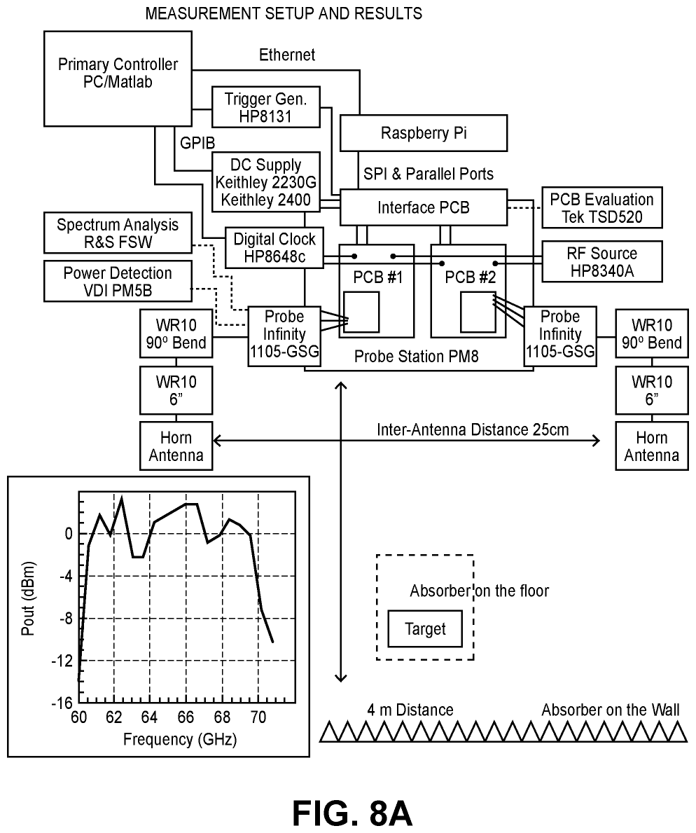

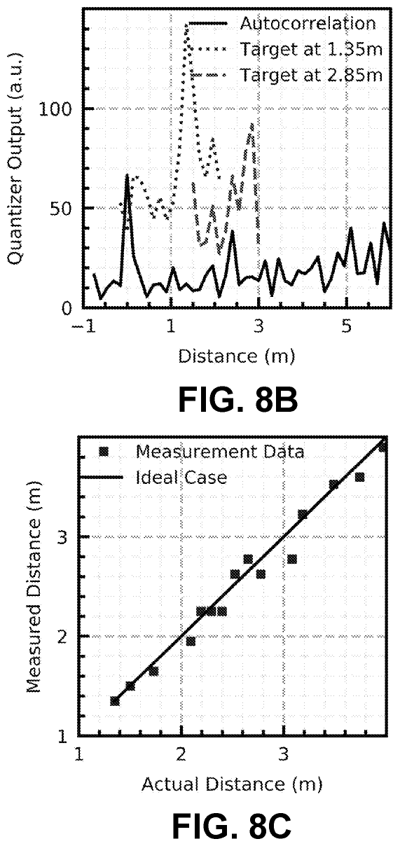

FIG. 8A is an example measurement setup and test results for the digital radar system of this disclosure. For the example of FIGS. 8A-8C, the radar system, e.g., a prototype radar system 100 and 200 described above in relation to FIGS. 1 and 2 prototype of the proposed system was fabricated in the TSMC 65 nm GP process. The particular example implementation of the prototype included a transmitter and receiver and can be programmed to operate in both mono-static and multi-static fashion.

The example of FIG. 8A shows the multi-static measurement setup with two chips mounted on two separate test boards. For over-the-air testing, the TX and RX chips share the same clock and LO and their outputs connect to parallel horn antennas through two GSG probes and 90 degree bends. A software interface programs the transmitter digital bit stream and reads the correlator output from the receiver SRAM memory. The chip consumes a total of 407 mW mainly from a 1V supply, including a 1.8V supply for the analog baseband. The resulting total power consumed by the baseband processing and digital backend is 38 mW. The transmitter and receiver front-ends consume 45 mW and 77 mW, respectively, and the remainder of the power is consumed by the multiplier chain and LO buffers. For over-the-air measurements, the test setup in the example of FIG. 8A included absorbers on the wall behind and on the floor underneath the target object to reduce clutter reflection.

FIGS. 8B and 8C are graphs illustrating the test results from the measurement setup for the radar system of this disclosure. FIG. 8B shows the measured correlator output, e.g., the output of correlator 130 described above in relation to FIG. 1, with a 1 Gbps bit stream indicating the location of the measured peak of the correlator output. The first setup shows the auto-correlation of the mono-static chip due to self-leakage.

The leakage and the resulting auto-correlation for the over-the-air measurements disappears below the noise floor after switching to the multi-static setup. For subsequent tests, as shown in FIG. 8C, measurements for moving the target between the minimum and maximum possible distance in the test lab and compare the physical distance with the measured distance. FIG. 8C demonstrates that the measured distance remains linear and its absolute and RMS errors are less than 25 cm and 11.6 cm, respectively. The expected theoretical range resolution R=cτ/2 for a 1 Gpbs pulse sensor is 15 cm which indicates both the relative and absolute accuracy of this radar are close to its fundamental limits. Table 1 compares the performance summary of this chip with other radar systems, e.g., radar systems A, B, C and D. The data listed in Table 1 demonstrates a comparison sensing performance of the proposed radar with superior energy efficiency.

TABLE 1
Comparison

| | This | | | | |
|---|---|---|---|---|---|
| | work | A | B | C | D |
| CMOS technology | 65 nm | 28 nm | 28 nm | 45 nm | 65 nm |
| Modulation | BPSK | GMSK | BPSK | FMCW | FMCW |
| Channels (TX/RX) | 1/1 | 12/8 | 2/2 | 3/4 | 1/1 |
| Combined TX Pout | 2.8 | 19.6 | 8.5 | 10.8 | 2 |
| (dBm) | | | | | |
| TX Frequency | 61-70 | 77-79 | 79 | 7781 | 80-85 |
| (GHz) | | | | | |
| PN (dBc/Hz @ 1 | −101 | — | −85 | −91 | −113 |
| MHz) | | | | | |
| RX IF BW (GHz) | 0.1-2 | 0.25-2 | 2 | 0.015 | — |
| Baseband Power | 38 | >1000 | 340 | >1000 | — |
| (mW) | | | | | |
| TRX Power per | 122 | 800 | 194 | — | 120 |
| channel (mW) | | | | | |
| Total SoC power | 407 | 15000 | 1000 | 3500 | — |
| (mW) | | | | | |
| Die area (mm²) | 2 | 14 | 7.9 | 22 | 1 |
| Measurement | 11.6 | — | — | — | — |
| Precision (cm) | | | | | |

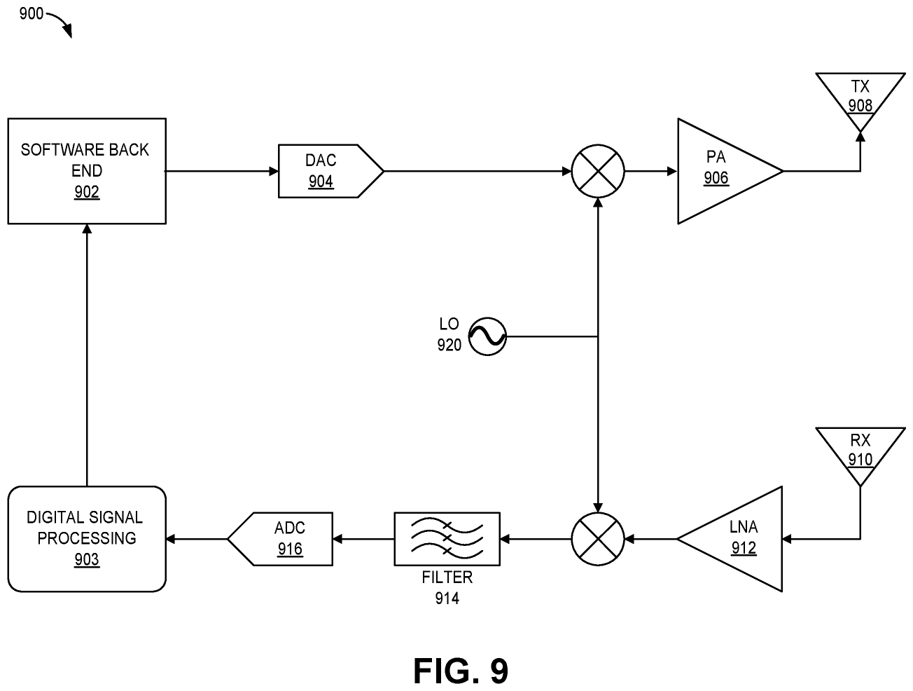

FIG. 9 is an example phase modulated radar system. Radar system 900 in FIG. 9 includes software back-end 902, DAC 904, power amplifier 906 and transmit antenna 908. The output frequency from LO 920 upconverts the signal through a mixer. Reflected echo signals from targets arrive at receive antenna 910 and pass through LNA 912, and mixed with the signal from LO 920 to down convert the received echo signal. the signal may be filtered, e.g., at filter 914 and converted to a digital signal 916 before processing by DSP 903.

In contrast to system 100 and 200 of this disclosure described above in relation to FIGS. 1 and 2, and the circuitry described above in relation to FIGS. 3-8C, the convolution operation of system 900 is performed in the digital domain using high performance ADCs that impose a scaling limit on speed and resolution. To overcome this constraint, the radar system of this disclosure implements the correlator at the analog front-end prior to any digital processing which enables high speed and energy efficient processing at scale.

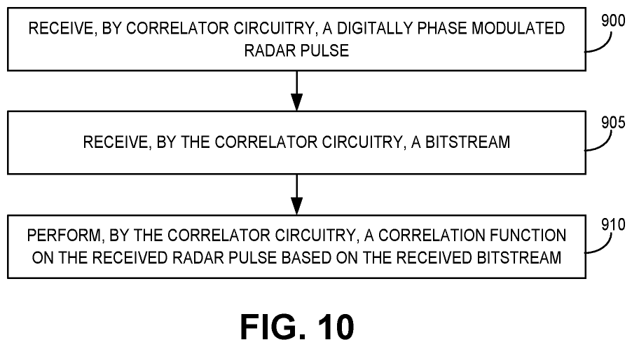

FIG. 10 is a flowchart illustrating an example operation of the digital radar system of this disclosure. As seen in the example of FIG. 10, correlator circuitry, e.g., correlator circuitry 130 described above in relation to FIG. 1, may receive digitally phase modulated radar pulse (900). In some examples the radar pulse may be an echo reflected from a target, e.g., walls and objects in a room being measured for 3D size. In other examples, the radar signal may be received directly from a separate radar transmitter.

Next, the correlator circuitry may receive a bitstream (905), such as bitstream 107 of FIG. 1 or a bitstream from SRAM #1, as described above in relation to FIG. 2. The bitstream may be based on the transmitted radar pulse and used to perform the correlation function on the received radar pulse, e.g., to decode the received radar pulse. In the example of a physically separate radar transmitter, both the transmit circuitry and the receive circuitry may store a similar bitstream in a respective memory device. The stored bitstream may be used to transmit the radar pulse by the transmit circuitry. The correlator circuitry may use the respective stored bitstream, e.g., the same phase sequence as the transmitter bitstream, to decode the received radar pulse. Next the correlator circuitry may perform a correlation function on the received radar pulse based on the received bitstream (910) and generate a correlated analog signal.

The techniques of this disclosure may also be described in the following examples.

Example 1: A radar system comprising: receive circuitry configured to process an analog radar pulse that is digital phase modulated; correlator circuitry configured to: receive the analog radar pulse; receive a bitstream to decode the received radar pulse; perform a correlation function on the received radar pulse based on the bitstream to generate a correlated analog signal; and output the correlated analog signal to digital conversion circuitry.

Example 2: The system of example 1, wherein the correlator circuitry comprises: a multiplier; and an integrator, wherein the combination of the multiplier and the integrator is configured to realize a transfer function of a linear matched filter.

Example 3: The system of examples 1 and 2, wherein the correlator circuitry further comprises: a quantizer, configured to receive the output from the integrator; and a counter, configured to receive the output from the quantizer, wherein the quantizer and counter extend a linear dynamic range of the integrator.

Example 4: The system of any of examples 1 through 3, wherein the correlator is arranged to compress digital data based on the received analog radar pulse by sampling the received analog radar pulse.

Example 5: The system of any of examples 1 through 4, wherein the received analog radar pulse is a radar echo signal reflected from a target.

Example 6: The system of any of examples 1 through 5, wherein the received analog radar pulse is received directly from radar transmitter that transmits signals that are digital phase modulated.

Example 7: The system of example 6, wherein the radar system comprises both the receive circuitry and the radar transmitter.

Example 8: The system of any of examples 1 through 7, wherein the bitstream received by the correlator circuitry is based on a transmitted radar pulse from a radar transmitter, and wherein the transmitted radar pulse is time delayed before the correlator circuitry receives the transmitted radar pulse.

Example 9: The system of any of examples 1 through 8, wherein the correlator circuitry receives the analog echo signals via a power splitter and an amplifier that drives two differential paths connected to the correlator circuitry, and wherein the differential amplifier provides reverse isolation to isolate the two differential paths.

Example 10: A device implemented in circuitry comprising: receive circuitry configured to process an analog radar pulse that is digital phase modulated; correlator circuitry configured to: receive the analog radar pulse; receive a bitstream to decode the received radar pulse; perform a correlation function on the received radar pulse based on the bitstream to generate a correlated analog signal; and output the correlated analog signal to digital conversion circuitry.

Example 11: The device of example 10, wherein the circuitry is implemented on an integrated circuit.

Example 12: The device of any of examples 10 and 11, wherein the correlator circuitry comprises: a multiplier; and an integrator, wherein the combination of the multiplier and the integrator is configured to realize a transfer function of a linear matched filter.

Example 13: The device of any of examples 10 through 12, wherein the correlator circuitry further comprises: a quantizer, configured to receive the output from the integrator; and a counter, configured to receive the output from the quantizer, wherein the quantizer and counter extend a linear dynamic range of the integrator.

Example 14: The device of any of examples 10 through 13, wherein the correlator is arranged to compress digital data based on the received analog radar pulse by sampling the received analog radar pulse.

Example 15: The device of any of examples 10 through 14, wherein the bitstream received by the correlator circuitry is based on a transmitted radar pulse from a radar transmitter, and wherein the transmitted radar pulse is time delayed before the correlator circuitry receives the transmitted radar pulse.

Example 16: The device of any of examples 10 through 15, wherein the correlator circuitry receives the radar pulse via a power splitter and a differential amplifier that drives two differential paths connected to the correlator circuitry, and wherein the differential amplifier provides reverse isolation to isolate the two differential paths.

Example 17: A method comprising: receiving, by correlator circuitry, a digitally phase modulated radar pulse; receiving, by the correlator circuitry, a bitstream to decode the received radar pulse; performing, by the correlator circuitry, a correlation function on the received radar pulse based on the received bitstream to generate a correlated analog signal; output the correlated analog signal to digital conversion circuitry.

Example 18: The method of example 17, wherein the radar pulse is reflected from a target.

Example 19: The method of any of examples 17 and 18, wherein the bitstream is based on a transmitted radar pulse from transmit circuitry operatively coupled to the correlator circuitry, wherein the transmit circuitry is: configured to transmit the analog radar pulse via a transmit antenna, and the transmitted the analog radar pulse is the digitally phase modulated radar pulse.

Various examples of the disclosure have been described. These and other examples are within the scope of the following claims.

What is claimed is:

1. A radar system comprising:
receive circuitry configured to process an analog radar pulse that is digital phase modulated; and
correlator circuitry configured to:
receive the analog radar pulse;
receive a bitstream to decode the received radar pulse;
perform a correlation function on the received radar pulse based on the bitstream to generate a correlated analog signal; and
output the correlated analog signal to digital conversion circuitry.

2. The system of claim 1, wherein the correlator circuitry comprises:
a multiplier; and
an integrator, wherein the combination of the multiplier and the integrator is configured to realize a transfer function of a linear matched filter.

3. The system of claim 2, wherein the correlator circuitry further comprises:
a quantizer, configured to receive the output from the integrator; and
a counter, configured to receive the output from the quantizer, wherein the quantizer and counter extend a linear dynamic range of the integrator.

4. The system of claim 3, wherein the correlator is arranged to compress digital data based on the received analog radar pulse by sampling the received analog radar pulse.

5. The system of 1, wherein the received analog radar pulse is a radar echo signal reflected from a target.

6. The system of claim 3, wherein the received analog radar pulse is received directly from an radar transmitter that transmits signals that are digital phase modulated.

7. The system of claim 6, wherein the radar system comprises both the receive circuitry and the radar transmitter.

8. The system of claim 1,
wherein the bitstream received by the correlator circuitry is based on a transmitted radar pulse from a radar transmitter, and
wherein the transmitted radar pulse is time delayed before the correlator circuitry receives the transmitted radar pulse.

9. The system of claim 1,
wherein the correlator circuitry receives the analog radar pulse via a power splitter and a differential amplifier that drives two differential paths connected to the correlator circuitry, and
wherein the differential amplifier provides reverse isolation to isolate the two differential paths.

10. A device implemented in circuitry comprising:
receive circuitry configured to process an analog radar pulse that is digital phase modulated;
correlator circuitry configured to:
receive the analog radar pulse;
receive a bitstream to decode the received analog radar pulse;
perform a correlation function on the received analog radar pulse based on the bitstream to generate a correlated analog signal;
output the correlated analog signal to digital conversion circuitry.

11. The device of claim 10, wherein the circuitry is implemented on an integrated circuit.

12. The device of claim 10, wherein the correlator circuitry comprises:
a multiplier; and
an integrator, wherein the combination of the multiplier and the integrator is configured to realize a transfer function of a linear matched filter.

13. The device of claim 12, wherein the correlator circuitry further comprises:
a quantizer, configured to receive the output from the integrator; and
a counter, configured to receive the output from the quantizer, wherein the quantizer and counter extend a linear dynamic range of the integrator.

14. The device of claim 13, wherein the correlator is arranged to compress digital data based on the received analog radar pulse by sampling the received analog radar pulse.

15. The device of claim 10,
wherein the bitstream received by the correlator circuitry is based on a transmitted radar pulse from a radar transmitter, and
wherein the transmitted radar pulse is time delayed before the correlator circuitry receives the transmitted radar pulse.

16. The device of claim 10,
wherein the correlator receives the radar pulse via a power splitter and a differential amplifier that drives two differential paths connected to the correlator, and
wherein the differential amplifier provides reverse isolation to isolate the two differential paths.

17. A method comprising:
receiving, by correlator circuitry, a digitally phase modulated radar pulse;
receiving, by the correlator circuitry, a bitstream to decode the received radar pulse;
performing, by the correlator circuitry, a correlation function on the received radar pulse based on the received bitstream to generate a correlated analog signal;
output the correlated analog signal to digital conversion circuitry.

18. The method of claim 17, wherein the radar pulse is reflected from a target.

19. The method of claim 17,
wherein the bitstream is based on a transmitted radar pulse from transmit circuitry operatively coupled to the correlator circuitry,
wherein the transmit circuitry is:
configured to transmit the analog radar pulse via a transmit antenna, and
the transmitted radar pulse is the digitally phase modulated radar pulse.
